(19) United States
(12) Patent Application Publication
(10) Pub. No.: US 2014/0167721 A1
(43) Pub. Date: Jun. 19, 2014

(54) POWER SUPPLY DEVICE

(71) Applicant: FUJITSU SEMICONDUCTOR LIMITED, Yokohama-shi (JP)

(72) Inventors: Yuji Ito, Hachiouji (JP); Masato Yokomaku, Yokohama (JP)

(73) Assignee: FUJITSU SEMICONDUCTOR LIMITED, Yokohama-shi (JP)

(21) Appl. No.: 14/057,839

(22) Filed: Oct. 18, 2013

(30) Foreign Application Priority Data
Dec. 19, 2012 (JP) 2012-276837

(51) Int. Cl. H02M 7/217

(52) U.S. Cl. CPC H02M 7/217
USPC 323/282

(57) ABSTRACT

A power supply device includes: a first transistor that switches a first current flowing between a first terminal and a second terminal of the first transistor; a second transistor that has a first terminal connected to the first terminal of the first transistor and a control terminal connected to a control terminal of the first transistor and is formed in a chip in which the first transistor is formed; a current source that supplies a second current between the first and second terminals of the second transistor; and a control part that performs a turn-on and turn-off control of the first transistor on the basis of voltages of the second terminals of the first and second transistors.

### CROSS-REFERENCE TO RELATED APPLICATION

This application is based upon and claims the benefit of priority of the prior Japanese Patent Application No. 2012-276837, filed on Dec. 19, 2012, the entire contents of which are incorporated herein by reference.

### FIELD

A certain aspect of the embodiments discussed herein is related to a power supply device.

### BACKGROUND

As power supply devices for voltage conversion, there are known non-isolation type step-up or step-down switching regulators (for example, Patent Documents 1 through 4) and isolation type regulators using transformers.

Patent Document 1: Japanese Laid-Open Patent Publication No. 2005-117810;

Patent Document 2: Japanese Laid-Open Patent Publication No. 2010-114993;

Patent Document 3: Japanese Laid-Open Patent Publication No. 2010-268542; and

Patent Document 4: Japanese Laid-Open Patent Publication No. 2011-188647.

In some power supply devices, current is sensed and a transistor is turned on and off. If a resistor is used to sense such current, a power loss occurs.

### SUMMARY

According to an aspect of the present invention, there is provided a power supply device including: a first transistor that switches a first current flowing between a first terminal and a second terminal of the first transistor; a second transistor that has a first terminal connected to the first terminal of the first transistor and a control terminal connected to a control terminal of the first transistor and is formed in a chip in which the first transistor is formed; a current source that supplies a second current between the first and second terminals of the second transistor; and a control part that performs a turn-on and turn-off control of the first transistor on the basis of voltages of the second terminals of the first and second transistors.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a circuit diagram of a power supply device in accordance with a first comparative example;

FIG. 2 is a circuit diagram of a power supply device in accordance with a second comparative example;

FIG. 3 is a circuit diagram of a power supply device in accordance with a first embodiment;

FIG. 4 is a circuit diagram of a power supply device in accordance with a second embodiment;

FIG. 5 is a circuit diagram of exemplary structures of a shutdown circuit and a delay circuit;

FIG. 6 is a circuit diagram of an exemplary structure of a peak hold circuit;

FIGS. 7A through 7C are diagrams illustrating the amount of detection associated with time;

FIG. 8 is a circuit diagram of a power supply device in accordance with a third embodiment;

FIG. 9 is a circuit diagram of a power supply device in accordance with a fourth embodiment;

FIG. 10 is a circuit diagram of a power supply device in accordance with a fifth embodiment;

FIG. 11 is a circuit diagram of a power supply device in accordance with a sixth embodiment; and

FIG. 12 is a circuit diagram of a power supply device in accordance with a seventh embodiment.

### DESCRIPTION OF EMBODIMENTS

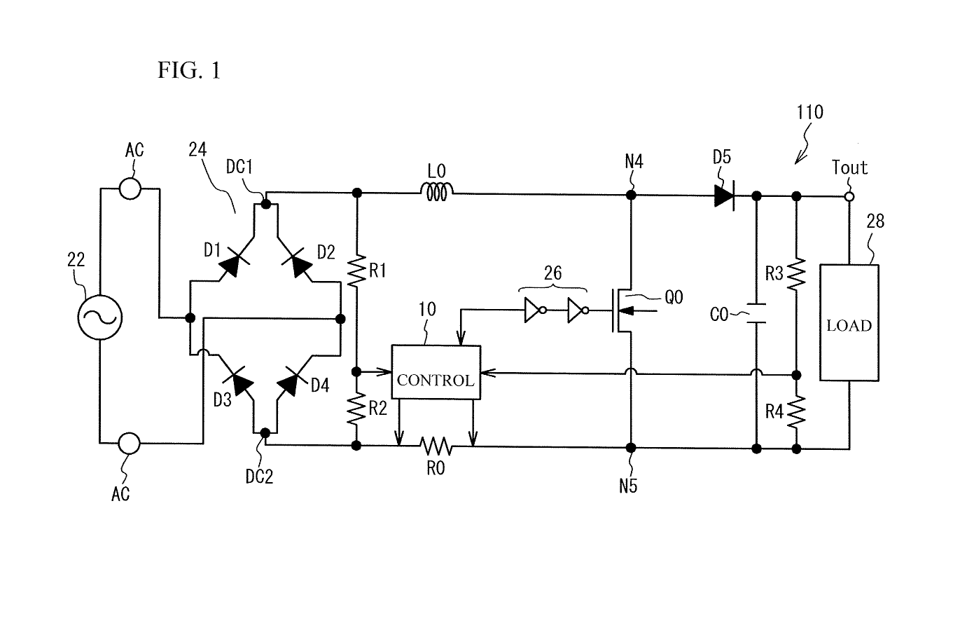

First, a description is given of comparative examples. The first comparative example is an exemplary step-up switching regulator. FIG. 1 is a circuit diagram of a power supply device in accordance with the first comparative example. Referring to FIG. 1, a power supply device 110 includes a rectifying circuit 24, an inductor L0, a diode D5, a capacitor C0, a transistor Q0, resistors R0 through R4, a control part 10 and a driver 26. The rectifying circuit 24 is a bride circuit composed of diodes D1 through D4. The rectifying circuit 24 rectifies AC power applied to an AC terminal AC from an AC power source 22, and outputs DC power to nodes DC1 and DC2. For example, the nodes DC1 and DC2 are a positive power supply and ground, respectively. The inductor L0 is connected to the node DC1 through one end and to a node N4 through the other end. The diode D5 is connected so that the anode is connected to the node N4 and the cathode is connected to an output terminal Tout. One end of the capacitor C0 is connected to the output terminal Tout and the other end is connected to the node N5. A load 28 is connected so that one end is connected to the output terminal Tout and the other end is connected to the node N5.

The drain of the transistor Q0 is connected to the node N4 and the source is connected to the node N5. The transistor Q0 is an n-type MOSFET (Metal Oxide Semiconductor Field Effect Transistor), for example. One end of the resistor R0 is connected to the node N5, and the other end is connected to the node DC2. The resistors R1 and R2 are connected in series between the nodes DC1 and DC2. The resistors R3 and R4 are connected in series between the output terminal Tout and the node N5.

The control part 10 is supplied with a voltage obtained by dividing the voltage of the node DC2 by the resistors R1 and R2 and another voltage obtained by dividing the voltage of the output terminal Tout by the resistors R3 and R4. The control part 10 detects current that flows through the resistor R0 from a potential difference between the both ends of the resistor R0. The control part 10 outputs a control signal for turning on/off the transistor Q0 on the basis of the voltage of the node DC1, the voltage of the output terminal Tout and the current flowing through the resistor R0. The control signal is amplified by a driver 26 including a plurality of amplifiers, and is then applied to the gate of the transistor Q0.

When the transistor Q0 is turned on, current flows through the inductor L0. When the transistor Q0 is turned off, the voltage of the node N4 and that of the output terminal Tout become higher than the voltage of the node DC1 due to the current that flows through the inductor L0. When the current that flows through the inductor L0 decreases, the transistor Q0 is turned on. At this time, even if the voltage of the node N4 becomes lower than that of the output terminal Tout, an inverse flow of current from the output terminal Tout to the node N4 is suppressed by the diode D5.

In the power supply device thus structured, the control part 10 is a PFC (Power Factor Correction) circuit that outputs the control signal for improvements in the power factor. Thus, the power factor is improved. However, in the first comparative example, the resistor R0 is provided for detecting the current. Thus, the resistor R0 results in a power loss.

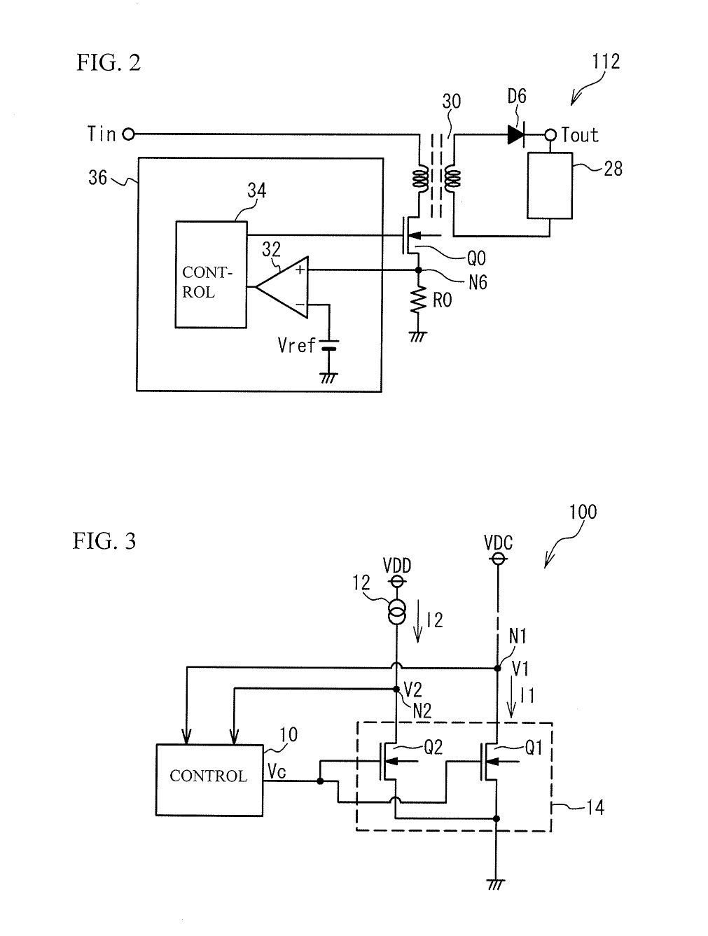

A second comparative example is an isolation type regulator. FIG. 2 is a circuit diagram of a power supply device in accordance with the second comparative example. A power supply device 112 includes a transformer 30, a diode D6, a transistor Q0, a resistor R0 and a control part 36. The primary side of the transformer 30 is connected to an input terminal Tin, and the secondary side thereof is connected to the output terminal Tout. The anode of the diode D6 is connected to the secondary side of the transformer 30, and the cathode thereof is connected to the output terminal Tout. The load 28 is connected to the output terminal Tout. The drain of the transistor Q0 is connected to the low-voltage side of the primary side of the transformer 30, and the source is connected to the node N6. One end of the resistor R0 is connected to the node N6, and the other end is connected to the ground.

The control part 36 includes a comparator 32 and a control circuit 34. The comparator 32 compares the voltage of the node N6 with a reference voltage Vref. The control circuit 34 applies a voltage lower than a threshold voltage to the gate of the transistor Q0 when the voltage of the node N6 is equal to or higher than the reference voltage Vref. Thus, the transistor Q0 is turned off.

With the above structure, if an overcurrent flows through the transformer 30, the transistor Q0 can be turned off. However, the second comparative example employs the resistor R0 for detecting the current. The resistor R0 results in a power loss.

Now, a description is given of embodiments capable of suppressing the power loss due to the resistor.

FIG. 3 is a circuit diagram of a power supply device in accordance with a first embodiment. Referring to FIG. 3, a power supply device 100 includes a transistor Q1 (first transistor), a transistor Q2 (second transistor), a current source 12 and a control part 10. The drain of the transistor Q1 is connected to a node N1, and a source thereof is connected to the ground. The node N1 is connected to a power supply VDC. A current I1 (first current) flows from the node N1 to the ground. The transistor Q1 switches the current I1 flowing between the source and the drain in accordance with a control signal Vc applied to the gate. The power supply VDC is a DC power supply, for example. The inductor L0 of the first comparative example or the transformer 30 of the second comparative example is connected between the node N1 and the power supply VDC. The drain of the transistor Q2 is connected to a node N2, and the source thereof is connected to the ground. The current source 12 is connected between a power supply VDD and the node N2. The power supply VDD is a DC power supply, for example. The voltage of the power supply VDD may be equal to or different from that of the power supply VDC. The current source 12 supplies a constant current I2 (second current) between the source and the drain of the transistor Q2. The magnitude of the current I2 may be appropriately selected in accordance with the current I1. The control part 10 turns on and off the transistors Q1 and Q2 by applying the control signal Vc to the gates of the transistors Q1 and Q2 on the basis of the voltage V1 of the node N1 and the voltage V2 of the node N2.

The transistors Q1 and Q2 are transistors including GaN, for example, and may be transistors having a GaN layer as a channel layer. The transistors Q1 and Q2 may be transistors that have an aluminum gallium nitride/gallium nitride (AlGaN/GaN) heterostructure on a substrate and the GaN layer is used as a channel layer. The substrate may be made of sapphire, silicon carbide (SiC), gallium nitride (GaN), or silicon (Si). The transistors Q1 and Q2 may be normally-on or normally-off transistors. The transistors Q1 and Q2 may be MOSFETs formed on a silicon substrate.

The transistors Q1 and Q2 are formed in a single or same chip 14. Thus, the transistors Q1 and Q2 have almost the same characteristics per unit size. The ratio of the sizes of the transistors Q1 and Q2 (for example, gate sizes) is 1:M (M>1). The sources of the transistors Q1 and Q2 are connected together, and the gates thereof are connected together. This connection sets the ratio of the currents I1 and I2 to 1:M. Thus, I1=V1/V2·M·I2. The control part 10 compensates for the temperature characteristic of the transistor Q1 from the voltages V1 and V2 to precisely detect the current I1 that flows through the transistor Q1 independently of the temperature.

According to the first embodiment, one (first terminal) of the source and the drain of the transistor Q2 is connected to one (first terminal) of the source and the drain of the transistor Q1. The gate (control terminal) of the transistor Q2 is connected to the gate (control terminal) of the transistor Q1. The above connections make it possible to detect the current I1 by the voltages V1 and V2. Further, since the transistors Q1 and Q2 are formed on the same chip 14, the temperature coefficients of the transistors Q1 and Q2 can be compensated for. Further, the differences among the transistors introduced during the fabrication process can be compensated for.

The size of the transistor Q2 is smaller than the size of the transistor Q1. Thus, the current I2 can be reduced. The connections on the sources and the drains of the transistors Q1 and Q2 may be interchanged. More specifically, one of the source and the drain of the transistor Q1 is connected to the node N1, and one of the source and the drain of the transistor Q2 is connected to the node N2, while the other terminals (second terminals) of the transistors Q1 and Q2 are connected together.

A voltage of tens of volts to hundreds of volts is applied between the source and the drain of the transistor Q1. The high-breakdown silicon MOSFET has the source formed on the backside of the chip. In this case, there is a difficulty in forming the transistors Q1 and Q2 on the same chip as in the case of the first embodiment. From this viewpoint, it is preferable that the transistors Q1 and Q2 are transistors including GaN. Thus, the transistor Q1 has a high breakdown voltage, and the transistors Q1 and Q2 can be formed on the same chip.

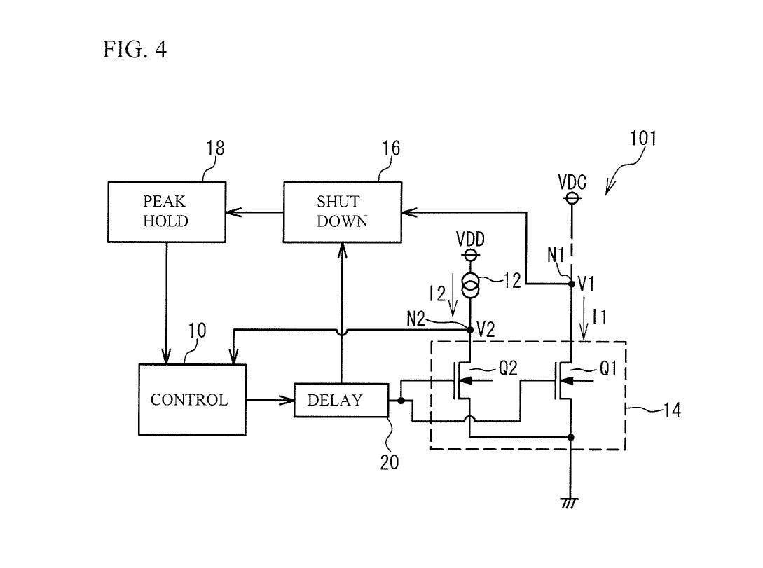

A second embodiment is an exemplary power supply device that includes a shutdown circuit, a peak hold circuit and a delay circuit. FIG. 4 is a circuit diagram of the power supply device in accordance with the second embodiment. Referring to FIG. 4, a power supply device 101 includes a shutdown circuit 16, a peak hold circuit 18 and a delay circuit 20. The shutdown circuit 16 shuts down or clamps the voltage V1 applied to the control part 10 from the node N1 when the control part 10 turns off the transistor Q1. The peak hold circuit 18 holds the peak of the voltage applied to the control part 10 from the node N1. The delay circuit 20 adjusts the turn-off and turn-on timings of the transistors Q1 and Q2 and the operation timing of the shutdown circuit 16. The delay circuit 20 causes the shutdown circuit 16 to release the shutdown or clamping of the voltage applied to the control part 10 after the transistor Q1 is turned on. The delay circuit 20 causes the shutdown circuit 16 to shut down or clamp of the voltage applied to the control part 10 before the transistor Q1 is turned off. The other structures of the second embodiment are the same as those of the first embodiment illustrated in FIG. 3, and a description thereof is omitted here. The second embodiment may be configured to have at least one of the shutdown circuit 16, the peak hold circuit 18 and the delay circuit 20.

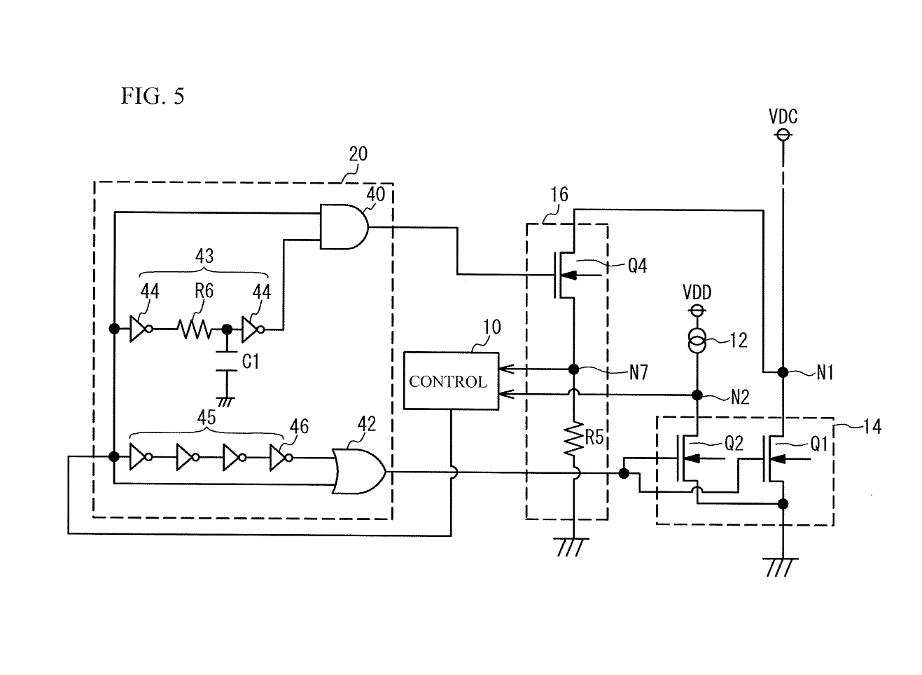

FIG. 5 is a circuit diagram of exemplary structures of the shutdown circuit 16 and the delay circuit 20. The shutdown circuit 16 includes a transistor Q4 and a resistor R5. The transistor Q4 is a transistor including GaN. The drain of the transistor Q4 is connected to the node N1, and the source is connected to a node N7. Alternatively, the drain of the transistor Q4 may be connected to the node N7, and the source is connected to the node N1. One end of the resistor R5 is connected to the node N7, and the other end is connected to the ground. A signal is applied to the gate of the transistor Q4 when the transistors Q1 and Q2 are turned off. When the transistors Q1 and Q2 are in the on states, the voltage of the node N1 is equal to a few volts. At this time, the transistor Q4 is in the on state. Thus, the potential of the node N7 is equal to that of the node N1. In contrast, when the transistors Q1 and Q2 are in the off states, the voltage of the node N1 is hundreds of volts. At this time, the transistor Q4 is in the off state. Thus, the potential of the node N7 is equal to or lower than a few volts.

The control part 10 may be formed by MOSFETs, for example. In this case, the breakdown voltage of the control part 10 is a few volts. If a voltage of hundreds of volts is applied to the control part 10, the control part 10 may be destroyed. According to the second embodiment, the shutdown circuit 16 shuts down the voltage applied to the control part 10 from the node N1 when the transistor Q1 is turned off. It is thus possible to suppress a high voltage from being applied to the control part 10 and to prevent the control part 10 from being destroyed. The shutdown circuit 16 may clamp the voltage applied to the control part 10 at a voltage lower than the voltage of the node N1.

The delay circuit 20 includes an AND circuit 40, an OR circuit 42 an circuits 43 and 45. A path from the control part 10 to the OR circuit 42 is divided into two paths. One of the two paths is directly input to the OR circuit 42. The other path is input to the OR circuit 42 through the circuit 45. The circuit 45 includes one or a plurality of inverters 46 that are connected in series between the input and the output. The circuit 45 delays the input signal. When the output of the control part 10 becomes high, the output of the OR circuit 42 becomes high immediately. When the output of the control part 10 becomes low, the output of the OR circuit 42 becomes low with a delay.

The path from the control part 10 to the AND circuit 40 is divided into two paths. One of the two paths is directly input to the AND circuit 40. The other path is input to the AND circuit 40 via the circuit 43. The circuit 43 includes one or a plurality of inverters 44 connected in series between the input and the output, a resistor R6 is connected between the input and the output, and a capacitor C1 connected in parallel. The circuit 43 has a delay that is active when the input changes to the high level from the low level and another delay that is active when the input changes to the low level from the high level, the former delay being larger than the later delay. The delay time of the circuit 43 from the low level to the high level is shorter than the delay time of the circuit 45. Thus, the transistor Q4 is turned on after the transistors Q1 and Q2 are turned on, and is turned off before the transistors Q1 and Q2 are turned off.

The transistor Q1 is turned on with a time constant of tens of nanoseconds to hundreds of nanoseconds after the high level is input to the gate of the transistor Q1. The transistor Q1 is turned off with a time constant of tens of nanoseconds to hundreds of nanoseconds after the low level is input to the gate of the transistor Q1. When the transistor Q1 is a transistor including GaN, the transistor Q1 has on and off time constants due to the current collapse phenomenon. For example, the on resistance is higher immediately after the transistor Q1 is turned on. According to the second embodiment, the delay circuit 20 releases the shutdown circuit 16 from shutting down or clamping the voltage input to the control part 10 after the transistor Q1 is turned on. Further, the shutdown circuit 16 is caused to shut down or claim the voltage input to the control part 10 before the transistor Q1 is turned off. It is thus possible to suppress a high voltage from being applied to the control part 10 when the transistor Q4 is turned on in a state in which the transistor Q1 is not yet turned on completely.

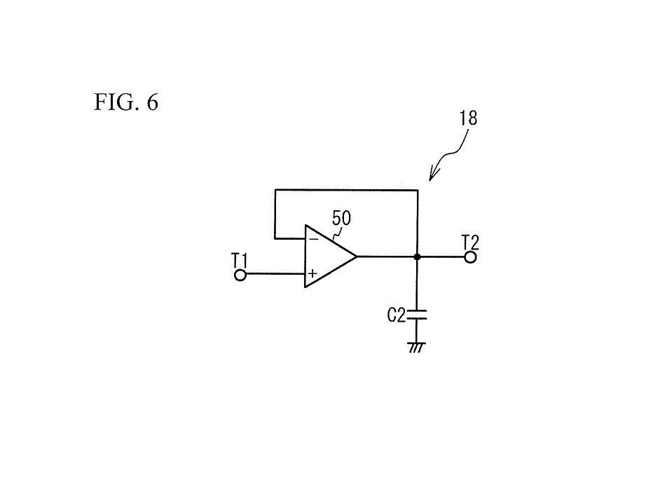

FIG. 6 is a circuit diagram of an exemplary structure of the peak hold circuit 18. Referring to FIG. 6, the peak hold circuit 18 includes a differential amplifier circuit 50 and a capacitor C2. The positive input of the differential amplifier circuit 50 is connected to an input terminal T1. The output of the differential amplifier circuit 50 is fed back to the negative input and is connected to an output terminal T2. One end of the capacitor C2 is connected to the terminal T2, and the other end is connected to the ground. The differential amplifier circuit 50 is set so that the sink ability is smaller than the source ability. When the potential of the terminal T1 rises, the output to the terminal T2 follows the rise immediately. When the potential of the terminal T1 falls, the output to the terminal T2 follows the fall with a delay. Thus, the peak hold circuit 18 holds the peak of the signal input to the terminal T1, and outputs the peak to the terminal T2.

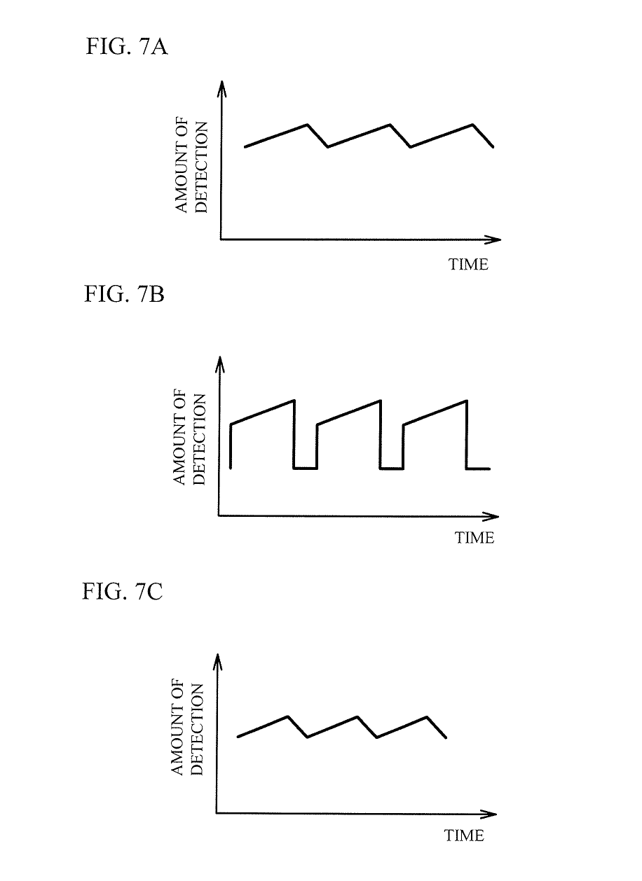

FIGS. 7A through 7C are diagrams of the detection amounts with time. FIG. 7A illustrates the amount of detection of current by the resistor R0 in the first comparative example. As illustrated in FIG. 7A, the amount of detection increases and decreases with time. The cycle of the amount of detection is the cycle with which the transistor Q1 is turned on and off. FIG. 7B illustrates the amount of detection of current in an example in which the first embodiment is applied to the first comparative example (fourth embodiment described later). As illustrated in FIG. 7B, when the transistor Q1 is turned off, regeneration current that flows from the load 28 to the node DC2 is not detected. FIG. 7C illustrates the amount of detection of current when the peak hold circuit of the second embodiment is used. As illustrated in FIG. 7C, even when the transistor Q1 is turned off, the regeneration current is generated by the peak hold circuit 18 in a pseudo-manner.

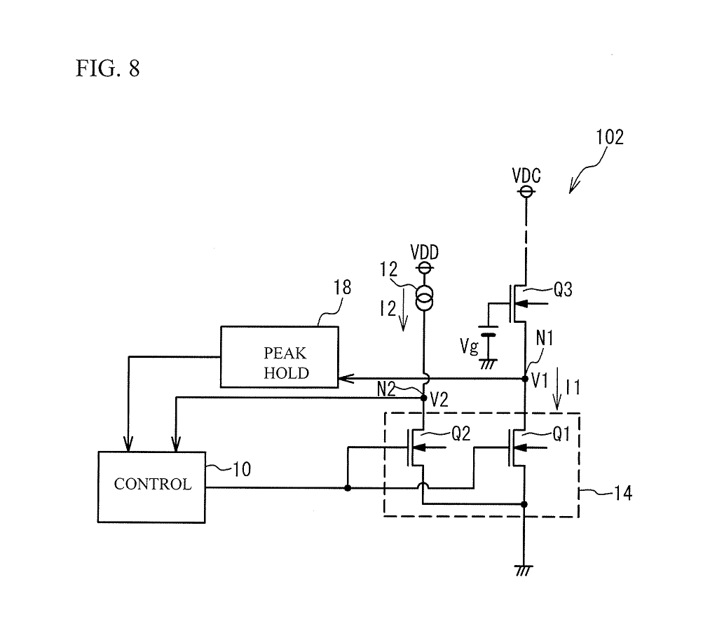

FIG. 8 is a circuit diagram of a power supply device in accordance with a third embodiment. Referring to FIG. 8, a power supply device 102 includes a transistor Q3 and the peak hold circuit 18. The drain of the transistor Q3 is connected to the power supply VDC, and the source is connected to the node N1, the gate being connected to a gate power supply Vg. The drain of the transistor Q3 may be connected to the node N1, and the source may be connected to the power supply VDC. The voltage of the node N1 is input to the control part 10 via the peak hold circuit 18. The peak hold circuit 18 may be the same as illustrated in FIG. 6. The peak hold circuit 18 may be omitted. The transistor Q3 is a transistor having a large breakdown voltage, and may be a transistor including GaN, for example. When the transistor Q1 is turned off, a high voltage is applied to the transistor Q3, and the voltage of the node N1 does not rise. It is thus possible to prevent the high voltage from being applied to the control part 10. The shutdown circuit employed in the second embodiment may be omitted. The other structures of the third embodiment are the same as those of the first embodiment, and a description thereof is omitted here.

According to the third embodiment, the transistor Q3 is cascaded between the transistor Q1 and the power supply VDC. It is thus possible to prevent the high voltage from being applied to the control part 10 when the transistor Q1 is turned off.

The source-drain breakdown voltage of the transistor Q3 is preferably higher than that of the transistor Q1. Thus, the transistor Q1 can be downsized. The transistor Q1 may be a MOSFET having a comparatively low breakdown voltage. For example, the transistors Q1 and Q2 and the control part 10 may be formed in the same chip.

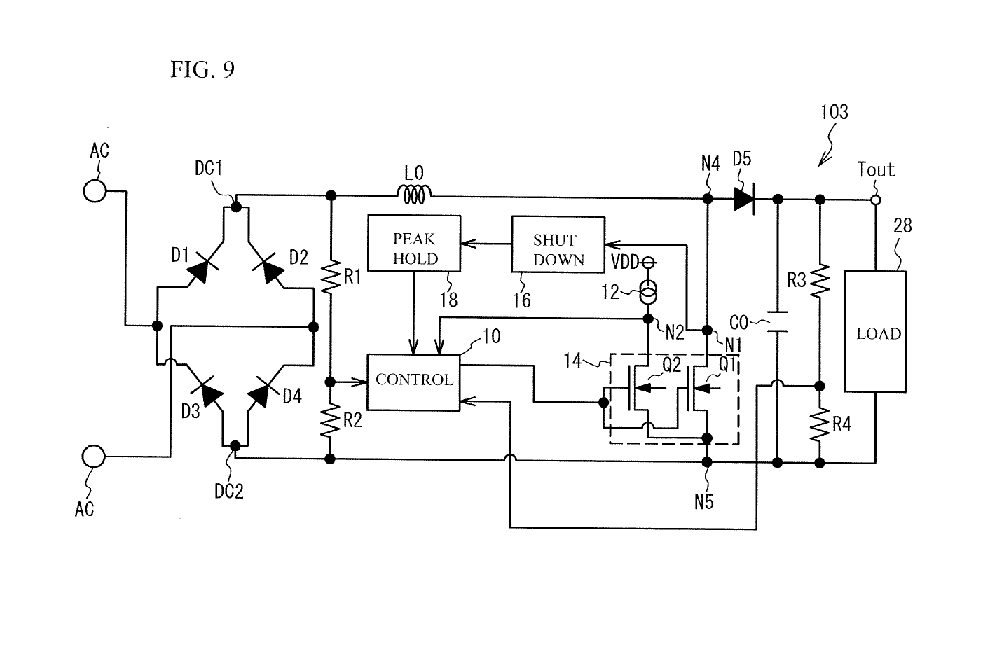

FIG. 9 is a circuit diagram of a power supply device in accordance with a fourth embodiment. Referring to FIG. 9, a power supply device 103 includes the transistors Q1 and Q2, the current source 12, the shutdown circuit 16, the peak hold circuit 18 and the control part 10, and does not include the resistor R0 that is used in the first comparative example illustrated in FIG. 1. The transistor Q2 is connected in parallel with the transistor Q1. The output of the control part 10 is commonly input to the gates of the transistors Q1 and Q2. The current source 12 is provided between the power supply VDD and the drain of the transistor Q2. The control part 10 is supplied with the voltage of the node N2 between the current source 12 and the transistor Q2 and the voltage of the node N1 between the node N4 and the transistor Q1. The node N1 is input to the control part 10 via the shutdown circuit 16 and the peak hold circuit 18. The other structures of the fourth embodiment are the same as those of the first comparative example, and a description thereof is omitted here.

As in the case of the fourth embodiment, the power supply device of the first or second embodiment may be applied to the non-isolation type step-up switching regulator.

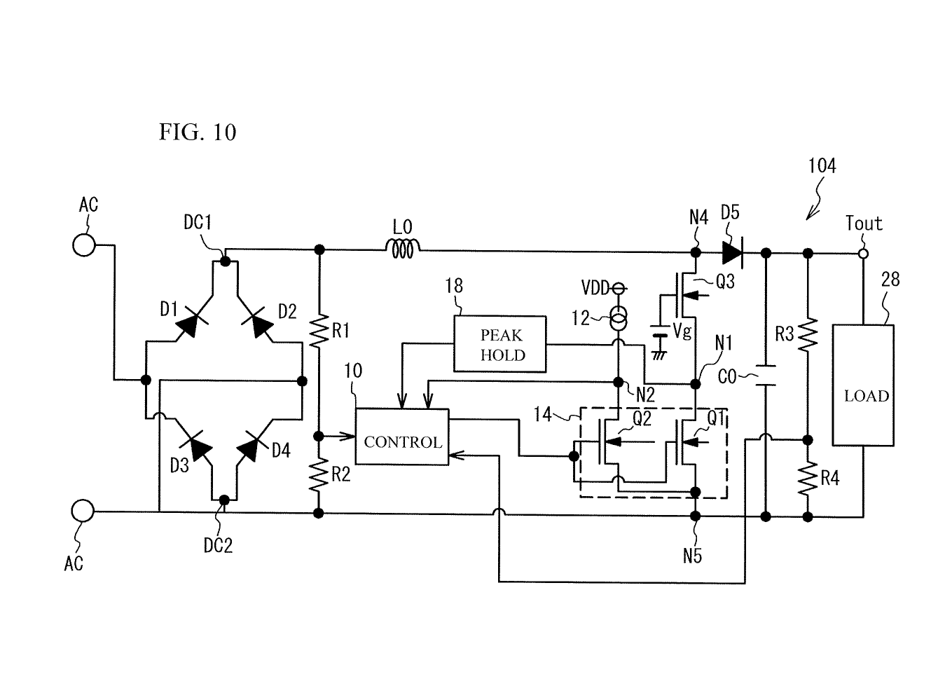

FIG. 10 is a circuit diagram of a power supply device in accordance with a fifth embodiment. Referring to FIG. 10, a power supply device 104 includes the transistor Q3 and does not have the shutdown circuit 16. The source of the transistor Q3 is connected to the node N1, and the drain is connected to the node N4, the gate being connected to the gate power supply Vg. The remaining structures of the fifth embodiment are the same as those of the fourth embodiment illustrated in FIG. 9, and a description thereof is omitted here.

As in the case of the fifth embodiment, the power supply device of the third embodiment may be applied to the non-isolation type step-up switching regulator. In the fifth embodiment, since the transistor Q3 is used, the shutdown circuit 16 may be omitted as in the case of the third embodiment.

As in the cases of the fourth and fifth embodiments, the current detection is implemented by the transistor Q1. Thus, the regeneration current from the load 28 to the DC node DC2 is not detected. From this viewpoint, the peak hold circuit 18 that generates the regeneration current in the pseudo-manner is preferably employed.

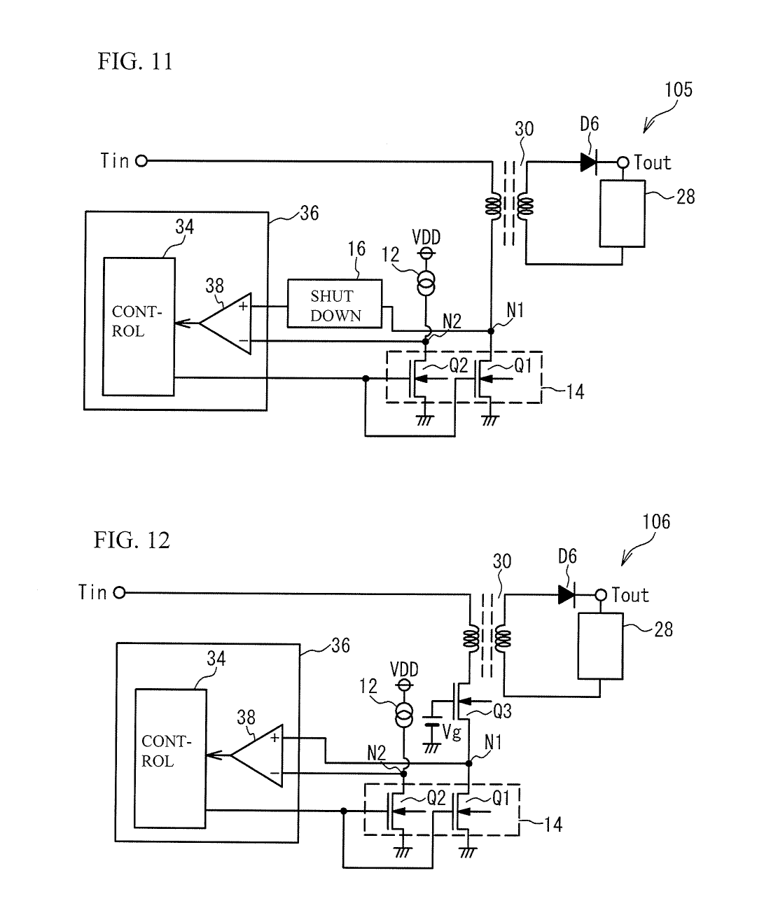

FIG. 11 is a circuit diagram of a power supply device in accordance with a sixth embodiment. Referring to FIG. 11, a power supply device 105 includes the transistors Q1and Q2, the current source 12, the shutdown circuit 16 and the control part 36, and does not have the resistor R0. The control part 36 includes a differential amplifier circuit 38 and the control circuit 34. The transistor Q2 is connected in parallel with the transistor Q1. The sources of the transistors Q1 and Q2 are commonly connected to the ground. The output of the control circuit 34 is input to the gates of the transistors Q1 and Q2. The drain of the transistor Q1 is connected to the transformer 30. The current source 12 is provided between the power supply VDD and the drain of the transistor Q2. The node N1 is input to the differential amplifier circuit 38 via the shutdown circuit 16. The differential amplifier circuit 38 compares the voltage of the node N2 between the current source 12 and the transistor Q2 with the voltage of the node N1 between the transformer 30 and the transistor Q1. The output of the comparator 32 is input to the control circuit 34. The control circuit 34 applies a voltage lower than the threshold voltage to the gate of the transistor Q1 when the voltage difference between the nodes N1 and N2 becomes equal to or higher than a predetermined value. Thus, the transistor Q1 is turned off. The delay circuit 20 illustrated in FIG. 5 may be connected to the shutdown circuit 16. The other structures are the same as those of the second comparative example, and a description thereof is omitted here.

As in the case of the sixth embodiment, the power supply device of the first or second embodiment may be applied to the isolation type regulator. The peak hold circuit 18 may be omitted in the sixth embodiment.

FIG. 12 is a circuit diagram of a power supply device in accordance with a seventh embodiment. Referring to FIG. 12, a power supply device 106 includes the transistor Q3, and does not have the shutdown circuit 16. The source of the transistor Q3 is connected to the node N1, and the drain is connected to the transformer 30, the gate being connected to the gate power supply Vg. The other structures of the seventh embodiment are the same as those of the fifth embodiment illustrated in FIG. 11, and a description thereof is omitted here.

As in the case of the seventh embodiment, the power supply device of the third embodiment may be applied to the isolation type regulator. Since the seventh embodiment employs the transistor Q3, the shutdown circuit 16 may be omitted.

As in the case of the fourth and fifth embodiments, the transistor Q1 is a main switch of the step-up power supply circuit. For example, the step-up power supply circuit may be a DC-DC converter that steps up the DC voltage of a power supply to generate another DC voltage. In this case, when the transistor Q1 is turned off, a high voltage is applied to the control part 10. From this viewpoint, it is preferable that the shutdown circuit 16 is employed. The power supply device is not limited to the step-up power supply circuit but may be a step-down power supply circuit (for example, a step-down DC-DC converter) or may be an inversion type power supply circuit (for example, an inversion type DC-DC converter).

In the fourth and fifth embodiments, the inductor L0 is connected between the other one of the source and the drain of the transistor Q1 and the power supply terminal. In the sixth and seventh embodiments, the transformer 30 is connected between the other one of the source and the drain of the transistor Q1 and the power supply terminal. In the case where the inductor L0 or the transformer 30 is connected, a high voltage is applied to the node N1. Therefore, it is preferable to use the shutdown circuit 16.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A power supply device comprising:
a first transistor that switches a first current flowing between a first terminal and a second terminal of the first transistor;
a second transistor that has a first terminal connected to the first terminal of the first transistor and a control terminal connected to a control terminal of the first transistor and is formed in a chip in which the first transistor is formed;
a current source that supplies a second current between the first and second terminals of the second transistor; and
a control part that performs a turn-on and turn-off control of the first transistor on the basis of voltages of the second terminals of the first and second transistors.

2. The power supply device according to claim 1, wherein the control part turns off the first transistor on the basis of a ratio of the voltages of the second terminals of the first and second transistors.

3. The power supply device according to claim 1, comprising a shutdown circuit that shuts down a voltage applied to the control part from the second terminal of the first transistor or clamps the voltage applied to the control part from the second terminal of the first transistor at a voltage lower than that of the second terminal of the first transistor, when the control part turns off the first transistor.

4. The power supply device according to claim 2, comprising a shutdown circuit that shuts down a voltage applied to the control part from the second terminal of the first transistor or clamps the voltage applied to the control part from the second terminal of the first transistor at a voltage lower than that of the second terminal of the first transistor, when the control part turns off the first transistor.

5. The power supply device according to claim 1, further comprising a third transistor cascaded between the first transistor and a power supply.

6. The power supply device according to claim 2, further comprising a third transistor cascaded between the first transistor and a power supply.

7. The power supply device according to claim 1, further comprising a peak hold circuit that holds a peak of a voltage applied to the control part from the second terminal of the first transistor.

8. The power supply device according to claim 2, further comprising a peak hold circuit that holds a peak of a voltage applied to the control part from the second terminal of the first transistor.

9. The power supply device according to claim 4, further comprising a delay circuit that causes the shutdown circuit to shut down or clamps the voltage applied to the control part before the first transistor is turned off and to release the shutdown circuit from shutting down or clamping the voltage applied to the control part after the first transistor is turned on.

10. The power supply device according to claim 5, further comprising a delay circuit that causes the shutdown circuit to shut down or clamps the voltage applied to the control part before the first transistor is turned off and to release the shutdown circuit from shutting down or clamping the voltage applied to the control part after the first transistor is turned on.

11. The power supply device according to claim 1, wherein the first and second transistors include GaN.

12. The power supply device according to claim 1, wherein the first transistor is a main switch of a step-up power supply circuit.

13. The power supply device according to claim 1, further comprising an inductor connected between the second terminal of the first transistor and a power supply terminal.

14. The power supply device according to claim 1, further comprising a transformer connected between the second terminal of the first transistor and a power supply terminal.

15. The power supply device according to claim 1, wherein the second transistor has a size smaller than that of the first transistor.
